(19) United States
(12) Patent Application Publication
(10) Pub. No.: US 2015/0133120 A1
(43) Pub. Date: May 14, 2015

(54) METHOD, SYSTEM AND COMPUTER-READABLE RECORDING MEDIUM FOR TRANSMITTING CONTENTS WITH SUPPORTING HAND-OVER

(71) Applicant: ARA NETWORK TECHNOLOGY CO., LTD., Daejeon (KR)

(72) Inventors: Woo Suk Yang, Daejeon (KR); Chul-Woong Yang, Daejeon (KR); Jae Hyuk Lee, Seoul (KR)

(73) Assignee: ARA NETWORK TECHNOLOGY. CO., LTD, Daejeon (KR)

(21) Appl. No.: 14/401,402

(22) PCT Filed: Apr. 8, 2013
(86) PCT No.: PCT/KR2013/002916

§ 371 Date: Nov. 14, 2014

(30) Foreign Application Priority Data
May 16, 2012 (KR) 10-2012-0052161
Sep. 27, 2012 (KR) 10-2012-0108307

(51) Int. Cl. H04W 36/00

(52) U.S. Cl. CPC H04W 36/0055
USPC 455/436

(57) ABSTRACT

According to one aspect of the present invention, the content transmission method supporting handover includes: (a) compressing, at a compressor, content transmitted from a server and transmitting the compressed content to a decompressor if a request for changing to a compression mode is received; and (b) transmitting, at a compressor, content transmitted from a server without compression to a client or another decompressor connected to the client after a handover occurs if the handover occurs at the client.

### FIELD OF THE INVENTION

The present disclosure relates to a method, system and computer-readable recording medium for transmitting contents with supporting hand-over.

More particularly, the present disclosure relates to a method, system and computer-readable recording medium for efficiently transmitting compressed or cached contents to mobile terminal device when hand-over occurs on mobile terminal device.

### BACKGROUND OF THE INVENTION

The technology of mobile telecommunication continues to evolve and it is now entering 4G (LTE) era beyond 3G networks.

As of year 2012, the download bandwidth of LTE mobile communication networks reaches up to 75 Mbps, which is very close to the speed of 100 Mbps wired communication networks. Such enhancement of mobile communication network infrastructure drives more traffic accordingly.

Also, unlike the legacy service provides small contents, large contents service provided by YouTube or IPTV and the common use of new terminal devices such as smart phone and smart pads increase data transmission exponentially on a mobile communication network and it will continue to do grow more.

This data explosion largely brings two problems on a mobile communication networks. First, it causes severe bottleneck phenomenon on backbone traffic line of mobile operator. The physical approach (such as line expansion) to this bottleneck problem is costly. Second, it significantly lowers the quality of service provided on a mobile communication network. If there is a bottleneck on backbone traffic line, it inevitably slows down data transmission which make Quality of Experience (QoE) worse for real-time service such as video and music service.

In order to resolve the issue of data explosion, there were numerous studies and introduced technologies such as data compression, data reduction, and data caching (keeping the mostly used data close to clients for later use from cache server) on an existing wired communication network.

However, it is difficult to apply the same technologies to mobile communication networks because Hand-Over phenomenon occurs when mobile communication terminal device changes its location. According to the conventional data compression and caching technology, data can be transmitted after Transmission Control Protocol (TCP) connection is established between user terminal device and specific devices such as compression device or cache server. In this case, receiving data using the existing data session may be problematic because it cannot make a connection between user terminal device and the devices upon Hand-Over occurrence or the cost for connection becomes too high.

Therefore, there are urgent needs for advanced technologies to deliver compressed or cached contents efficiently to mobile communication terminal device when Hand-Over occurs on the mobile device.

### SUMMARY OF THE INVENTION

It is, therefore, a primary object of the present disclosure to resolve all the problems caused by the above conventional technologies.

Another object of the present disclosure is to enable compressing and caching the contents using compressor and decompressor connected at entry and exit point of backbone and deliver compressed or cached contents efficiently to mobile communication terminal device when Hand-Over occurs on the mobile device.

Several representative configurations for achieving the above objects of the present disclosure are presented as follows.

According to one aspect of the present disclosure, provided is a method for delivering contents by the decompressor if Hand-Over occurs, the method comprising the stops, of: (a) transmitting, by a decompressor, a switching request to a compression mode or a cache mode to a compressor, based on the degree of matching between a content stored in a dictionary of the decompressor and a content transmitted from the compressor to the decompressor; (b) transmitting, by the decompressor, contents to a client based on the contents stored in the dictionary of the decompressor based on the transfer mode; and (c) performing, by the decompressor, one of operations which i) stopping the transmission of the contents to the client or ii) transmitting the contents stored in the dictionary of the decompressor by tunneling based on the transfer mode when hand-over occurs on the client.

According to one aspect of the present disclosure, provided is a method for delivering contents by the compressor if Hand-Over occurs, the method comprising the stops, of: (a) receiving, by a compressor, a switching request to a compression mode or a cache mode from the decompressor, based on the degree of matching between a content stored in a dictionary of the decompressor and a content transmitted from the compressor to the decompressor; (b) by the compressor, stopping to transmit contents that are received from a server to the decompressor based on the transfer mode, or compressing and then transmitting contents that are received from the server to the decompressor; and (c) performing, by the compressor, one of operations which i) transmitting contents received from the server to the client or another decompressor connected to the client after hand-over, or ii) controlling cached contents that are stored in the dictionary of the decompressor to be transmitted to the client or another decompressor connected to the client by tunneling based on the transfer mode when hand-over occurs on the client.

According to one aspect of the present disclosure, provided is a method for delivering contents by the compressor if Hand-Over occurs, the method comprising the steps of: (a) compressing and transmitting the incoming contents from the server to the decompressor when the request for changing into compression mode is received by the compressor; (b) transmitting the uncompressed contents received from the server to the client or another decompressor connected to the client after Hand-Over occurs on client.

In another aspect of the present disclosure, provided is a method for delivering contents by the decompressor if Hand-Over occurs, the method comprising the steps of: (a) sending a switching request to the compressor in order to change into the compression mode if the two contents (one is transmitted from the compressor to decompressor and another is stored to the dictionary of the decompressor) match each other more than the first threshold; (b) transmitting the corresponding content to the client for the content compressed by the compressor which is stored to the dictionary of decompressor; (c) stopping the delivery of content to the client when Hand-Over occurs on the client.

In another aspect of the present disclosure, provided is a method for delivering contents if Hand-Over occurs, the method comprising the steps of: (a) sending a switching request to the compressor by the decompressor in order to change into the compression mode if the two contents (one is transmitted from the compressor to decompressor and another is stored to the dictionary of the decompressor) match each other more than the first threshold; (b) compressing and sending the incoming contents from the server to the decompressor when the request for changing into compression mode is received by the compressor; (c) transmitting the corresponding content to the client for the content compressed by the compressor which is stored to the dictionary of decompressor; (d) transmitting the uncompressed contents received from the server to the client or another decompressor connected to the client by the compressor after Hand-Over occurs on client and stopping the delivery of content to the client by the decompressor when Hand-Over occurs on the client.

In another aspect of the present disclosure, provided is a method for delivering contents if Hand-Over occurs, the method comprising the steps of: (a) stopping the delivery of the incoming contents from the server to the decompressor when the request for changing into cache mode is received by the compressor; (b) transmitting the cached contents using tunneling technology when Hand-Over occurs on client, which was stored to the dictionary of decompressor 1 before the event of Hand-Over, to the client and another decompressor connected to the client by the compressor after Hand-Over occurs

In another aspect of the present disclosure, provided is a method for delivering contents if Hand-Over occurs, the method comprising the steps of: (a) sending a switching request to the compressor by the decompressor in order to change into the cache mode if the two contents (one is transmitted from the compressor to decompressor and another is stored to the dictionary of the decompressor) match each other more than the second threshold; (b) transmitting stored contents in the dictionary of the decompressor by the decompressor; (c) transmitting the cached contents using tunneling technology when Hand-Over occurs on client, which was stored to the dictionary of the decompressor before the event of Hand-Over, to the client and another decompressor connected to the client by the compressor after Hand-Over occurs

In another aspect of the present disclosure, provided is a method for delivering contents if Hand-Over occurs, the method comprising the steps of: (a) sending a switching request to the compressor by the decompressor in order to change into the cache mode if the two contents (one is transmitted from the compressor to decompressor and another is stored to the dictionary of the decompressor) match each other more than the second threshold; (b) stopping the delivery of the incoming contents from the server to the decompressor when the request for changing into cache mode is received by the compressor; (c) transmitting cached contents in the dictionary of the decompressor to client by the decompressor; (d) transmitting the cached contents using tunneling technology when Hand-Over occurs on client, which was stored to the dictionary of the decompressor before the event of Hand-Over, to the client or another decompressor connected to the client by the compressor after Hand-Over occurs

In another aspect of the present disclosure, provided is a system for delivering contents if Hand-Over occurs, the system comprising: a compression processor for compressing the incoming contents from server upon receiving the request for switch to compression mode; and a Hand-Over processor for transmitting the uncompressed content received from the server in the event of Hand-Over on client to the client or another decompressor connected to the client by the compressor after Hand-Over occurs.

In another aspect of the present disclosure, provided is a system for delivering contents if Hand-Over occurs, the system comprising: a decompressing processor for sending a switching request to the compressor in order to change into the compression mode if the two contents (one is transmitted from the compressor to decompressor and another is stored to the dictionary of the decompressor) match each other more than the first threshold and transmitting the corresponding content to the client for the content compressed by the compressor which is stored to the dictionary of decompressor; and a Hand-Over processor for stopping the delivery of content to the client when Hand-Over occurs on the client.

In another aspect of the present disclosure, provided is a system for delivering contents if Hand-Over occurs, the system comprising: a decompressor for sending a switching request to the compressor in order to change into the compression mode if the two contents (one is transmitted from the compressor to decompressor and another is stored to the dictionary of the decompressor) match each other more than the first threshold and transmitting the corresponding content to the client for the content compressed by the compressor which is stored to the dictionary of decompressor and stopping the delivery of content to the client when Hand-Over occurs on the client; and a compressor for compressing and transmitting the incoming contents from the server to the decompressor when the request for changing into compression mode is received by the compressor and transmitting the uncompressed contents received from the server to the client or another decompressor connected to the client after Hand-Over occurs on client.

In another aspect of the present disclosure, provided is a system for delivering contents if Hand-Over occurs, the system comprising: a caching processor of compressor for stopping the delivery of the incoming contents from the server to the decompressor upon receiving a request for changing into cache mode; and a Hand-Over processor for transmitting the cached contents using tunneling technology when Hand-Over occurs on client, which was stored to the dictionary of decompressor 1 before the event of Hand-Over, to the client and another decompressor connected to the client by the compressor after Hand-Over occurs

In another aspect of the present disclosure, provided is a system for delivering contents if Hand-Over occurs, the system comprising: a decompressor for sending a switching request to the compressor by the decompressor in order to change into the cache mode if the two contents (one is transmitted from the compressor to decompressor and another is stored to the dictionary of the decompressor) match each other more than the second threshold and transmitting cached contents in the dictionary of the decompressor to the client and transmitting the cached contents using tunneling technology when Hand-Over occurs on client, which was stored to the dictionary of the decompressor before the event of Hand-Over, to the client or another decompressor connected to the client by the compressor after Hand-Over occurs; and a compressor for stopping the delivery of the incoming contents from the server to the decompressor when the request for changing into cache mode is received by the compressor and transmitting the cached contents using tunneling technology when Hand-Over occurs on client, which was stored to the dictionary of the decompressor before the event of Hand-Over, to the client and another decompressor connected to the client by the compressor after Hand-Over occurs.

Besides, various methods and systems for implementation of the present disclosure, and a computer-readable recording medium for recording a computer program to execute any one of the above methods will be further provided.

One of major objectives of the present disclosure, unlike conventional technology, is to implement a Hand-Over feature on a mobile communication network and thereby, provide practical application on mobile communication networks.

Yet, another object of the present disclosure is to reduce network operating costs by saving bandwidth of backbone with data compression.

Still yet another object of the present disclosure is to enable enhanced QoE (Quality of Experience) along with bandwidth savings with data caching and thereby, provide high-levels of service, which is impossible in the conventional low bandwidth.

Further, the present disclosure is applicable to the conventional systems of mobile communication networks with no significant effect because it does not require any configuration change of existing network devices upon deployment—a compressor is placed at P-GW (Packet data Network Gateway) and a decompressor is placed near client in end of networks.

### BRIEF DESCRIPTION OF THE DRAWINGS

FIG. 1 schematically represents the entire system of content delivery system in accordance with one embodiment of the present disclosure for providing a Hand-Over on a mobile communication network.

FIG. 2 is a block diagram showing the internal structure of compressor 200 in accordance with one embodiment of the present disclosure.

FIG. 3 is a block diagram showing the internal structure of decompressor 300 in accordance with one embodiment of the present disclosure.

FIG. 4 is a block diagram showing how contents are delivered in compression mode in accordance with one embodiment of the present disclosure by way of illustration.

FIG. 5 is a block diagram showing how a Hand-Over is implemented in compression mode in accordance with one embodiment of the present disclosure by way of illustration.

FIG. 6 is a block diagram showing how contents are delivered in cache mode in accordance with one embodiment of the present disclosure by way of illustration.

FIG. 7 is a block diagram showing how a Hand-Over is implemented in cache mode in accordance with one embodiment of the present disclosure by way of illustration.

### DETAILED DESCRIPTION OF THE PREFERRED EMBODIMENTS

In the following detailed description, reference is made to the accompanying drawings that show, by way of illustration, specific embodiments in which the present disclosure may be practiced. These embodiments are described in sufficient detail to enable those skilled in the art to practice the present disclosure. It is to be understood that the various embodiments of the present disclosure, although different, are not necessarily mutually exclusive. For example, a particular feature, structure or characteristic described herein in connection with one embodiment may be implemented within other embodiments without departing from the spirit and scope of the present disclosure. In addition, it is to be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

In the following detailed description, the present disclosure will now be described in more detail, with reference to the accompanying drawings to enable those skilled in the art to practice the present disclosure easily.

Several key features of the present disclosure are presented as follows.

First, for normal delivery of compressed contents or cached contents in the event of Hand-Over of a client, it can make the client to be connected with other network device (e.g., a compressor, a decompressor and the like) other than server, not on application or transport layer (e.g., TCP, UDP) but on network layer. Accordingly, a network device between a server and a client may send or receive IP packet alone (that is, a datagram) or allow processing on a network layer.

Second, there is a specific operation mode that determines how a content is transmitted between a compressor and a decompressor for each session when a content is transmitted between a compressor and a decompressor. In normal mode, a compressor transmits a content to a client without compression process. In compression mode, a compressor compresses a content in order to transmit it to a client and then a decompressor decompresses the compressed content. In cache mode, a compressor stops transmitting a content and a decompressor transmits a cached content instead, which is stored in its own dictionary, to a client. In other words, it can reduce backbone traffic by compressing a content using the compression mode if compression is possible, and furthermore it can enhance QoE also using the cache mode by transmitting a cached content, which is stored to a decompressor's dictionary, to a client directly if caching is possible.

Third, in case that Hand-Over occurs on client, it can transmit a cached content, which is stored to decompressor's dictionary connected to a client before the event of Hand-Over, directly to a client or through a decompressor newly connected to a client after the event of Hand-Over through a tunnel on a communication network using tunneling technology.

### Configuration of the Entire System

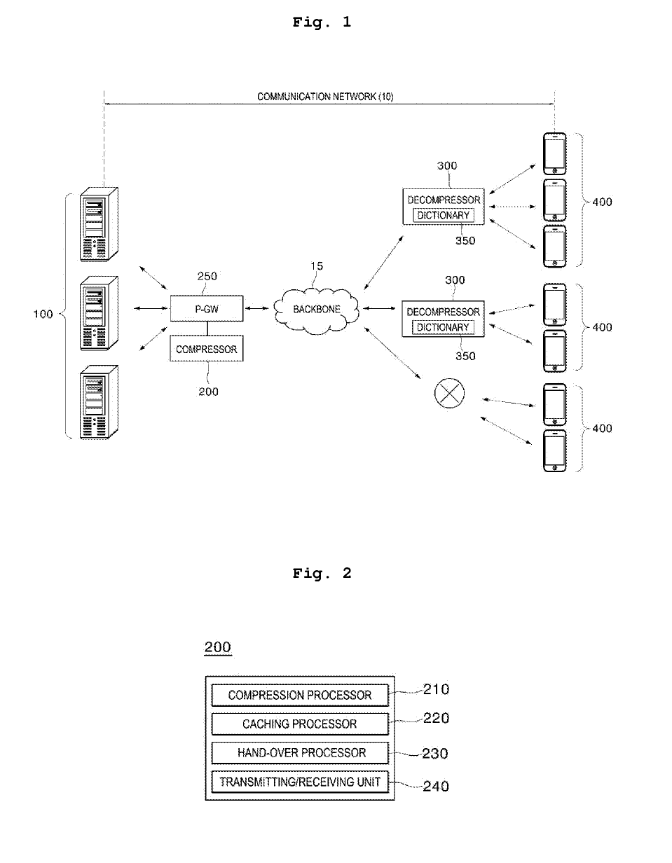

FIG. 1 schematically represents the entire system of content delivery system in accordance with one embodiment of the present disclosure for providing a Hand-Over on a mobile communication network.

With reference to FIG. 1, the entire system in accordance with one embodiment of the present disclosure may be comprised of a communication network 10 including backbone 15, a server 100, a compressor 200, a decompressor 300 and a client 400. Furthermore, it may include P-GW (Packet Data Gateway) 250 and dictionary 350 additionally.

First, a communication network 10 may be constructed on wires or wirelessly, and it should be understood that a communication network 10 comprises WWW (World Wide Web), WLAN (Wireless LAN), CDMA (Code Division Multiple Access), WCDMA (Wideband Code Division Multiple Access) or GSM (Global System for Mobile communications) communication network. Especially, the communication network 10 in accordance with one embodiment of the present disclosure may include a compressor 200, which each of its entry and exit point is connected to a compressor 200 and a decompressor 300, or a backbone 15 (a large dedicated line) that can collect data from a decompressor 300 to transmit it quickly.

Next, a sever 100 in accordance with one embodiment of the present disclosure can communicate with a client 400 via the communication network 10 consisting of compressor 200, decompressor 300 and P-GW (packet data network gateway) 250, and provide various types of information upon the request from a client 400. For example, the server 100 may be an operation server for an internet search portal site and various types of information may be provided to the client 400 for the information corresponding to a query, a web page, an image, a video, an audio, etc.

Further, a compressor 200 in accordance with one embodiment of the present disclosure may transmit the packet received from a server 100 to a decompressor 300 or a client 400 to enable content delivery from a server 100 to a client 400. In further detail, a compressor 200 in accordance with one embodiment of the present disclosure may transmits a content as it is with normal mode upon content delivery from a server 100, compresses a content with compression mode upon content delivery from a server 100, and stop transmitting a content with cache mode upon content delivery from a server 100. In case that Hand-Over occurs on a client 400 in cache mode, it transmits the cached contents using tunneling technology, which was stored to the dictionary 350 of decompressor 300 connected to a client 400 before the event of Hand-Over, directly to the client 400 or indirectly to the client 400 through a decompressor 300 newly connected after the event of Hand-Over.

FIG. 2 is a block diagram showing the internal structure of compressor 200 with one embodiment of the present disclosure compressor.

With reference to FIG. 2, a compressor 200 in one embodiment of the present disclosure may comprise a compression processor 210, a caching processor 220, a Hand-Over processor 230 and a transmitting/receiving unit 230. According to one embodiment of the present disclosure, all or part of the elements corresponding to reference numerals 210 to 240 may be a program module that communicates with an external system. Such program modules may be in the form of operating systems, application program modules and other program modules, and be included within a compressor 200 and be stored physically on various well-known memory devices. Alternatively, such program modules may be stored to a remote memory that can communicate with the compressor 200. Examples of such program modules include, but are not limited to, routines, subroutines, programs, objects, components and data structures for executing a specific task to be described later or a specific abstract data type according to one embodiment of the present disclosure.

Next, a decompressor 300 in accordance with one embodiment of the present disclosure can basically deliver contents received from a compressor 200 or another decompressor 300 or contents stored in its own dictionary 350 to a client 400 so as to transfer contents from a server 100 to a client 400. Additionally, in normal mode, a decompressor 300 in accordance with one embodiment of the present disclosure may transmit a content, which is received from a compressor 200, as it is to a client 400. In compression mode, a decompressor 300 may transmit the content corresponding to a compressed content received from a compressor 200 among contents stored in its own dictionary 350. In cache mode, a decompressor 300 transmits a cached content stored in its own dictionary 350 instead of transmitting the content corresponding to a compressed content received from a compressor 200. In case that Hand-Over occurs on a client 400 during cache mode, it may transmit a cached content using tunneling technology, which is stored to a dictionary 350A of a decompressor 300A connected to a client 400 before the event of Hand-Over, to a client 400 or a decompressor 300B connected to a client 400 after the event of Hand-Over. In this regard, a decompressor 300A may compress a content before transmitting it in case that a decompressor 300B, which is connected to a client 400 after the event of Hand-Over, makes a request for content compression upon delivery.

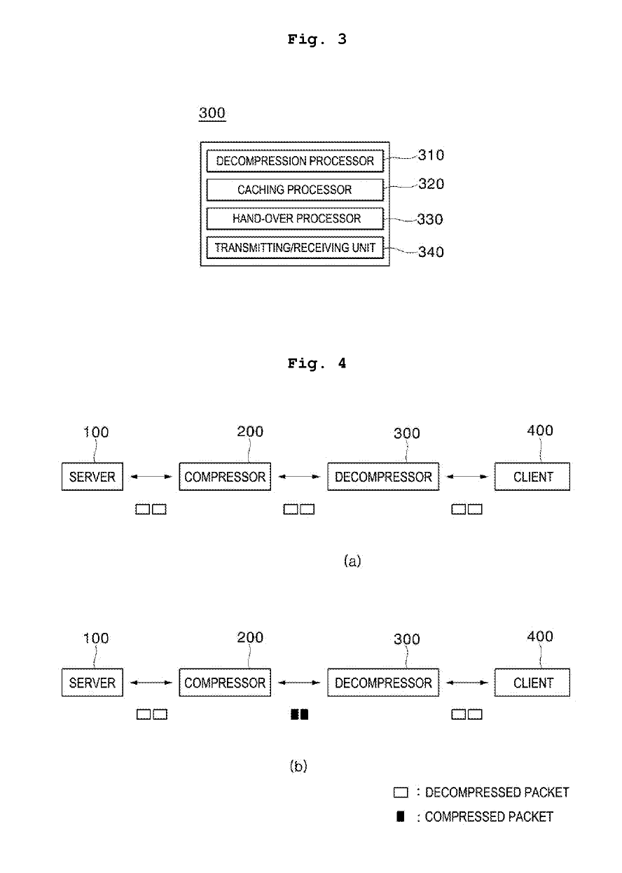

FIG. 3 is a block diagram showing the internal structure of decompressor 300 in accordance with one embodiment of the present disclosure compressor.

With reference to FIG. 3, a decompressor 300 in accordance with one embodiment of the present disclosure may comprise a decompression processor 310, a caching processor 320, a Hand-Over processor 330 and a transmitting/receiving unit 340. According to one embodiment of the present disclosure, all or part of the elements corresponding to reference numerals 310 to 340 may be a program module that communicates with an external system. Such program modules may be included in a decompressor 300 in the form of operating systems, application program modules and other program modules, and be stored physically on various well-known memory devices. Alternatively, such program modules may be stored to a remote memory that can communicate with the decompressor 300. Examples of such program modules include, but are not limited to, routines, subroutines, programs, objects, components and data structures for executing a specific task to be described later or a specific abstract data type according to one embodiment of the present disclosure.

Next, a client 400 in accordance with one embodiment of the present disclosure may be a device can connect to a communication network and communicate with each other. Examples of a client 400 are a personal computer (e.g., a notebook computer), a PDA, a tablet computer, a smart phone, a mobile phone and the like, each of which has a memory and a microprocessor for computational processes. According to one embodiment of the present disclosure, a client 400 is a mobile communication terminal device and it can move in physical space, which may cause a Hand-Over phenomenon by the change of communication network to which a client 400 belongs.

### Compression Mode and Configuration of a Hand-Over in Compression Mode

Hereinafter, according to one embodiment of the present disclosure, the configuration of content delivery in compression mode and the configuration in the event of Hand-Over in compression mode will be described in detail.

According to one embodiment of the present disclosure, there are two network devices on communication network 10 in case of content delivery, which are a compressor 200 and a decompressor 300. A compressor 200 compresses a content and transmit it to a decompressor 300 and a decompressor 300 decompresses the content and transmit it to a client 400 using a content corresponding to the compressed content among the contents stored to a dictionary 350. Therefore, it may reduce transmission bandwidth on a backbone 15 between a compressor 200 and a decompressor 300.

FIG. 4 is a block diagram showing the delivery of content in compression mode in accordance with to one embodiment of the present disclosure.

### (1) Operation of a Compressor 200

First, according to one embodiment of the present disclosure, a compressor 200 can retransmit the packet (e.g., the packet containing the information about content request to a server 100), which is received from a client 400, as it is to a server 100. Herein, it does not establish a TCP connection between a compressor 200 and a client 400 in the transport layer, whereas, a compressor 200 receives a datagram packet from a client 400 in the network layer.

A compressor 200 in accordance with to one embodiment of the present disclosure may receive a data, which compromises a content, from a server 100 as a packet consisting of packet header and payload (so to speak, actual data). Herein, it does not establish a TCP connection between a compressor 200 and a sever 100 in the transport layer, whereas, a compressor 200 receives a datagram packet from a server 100 in the network layer.

According to one embodiment of the present disclosure, a compressor 200 can retransmit the uncompressed packet, which is received from a server 100, to a decompressor 300 in normal mode as shown in FIG. 4 (a).

According to one embodiment of the present disclosure, based on configured compression algorithm, a compressor 200 in compression mode compresses the payload of packet, which is received from a server 100, to generate a compressed packet. Furthermore, a compressor 200 may transmit the above compressed packet to a decompressor 300 and transmit metadata (e.g., compressed MD5 signature information, protocol information and the like) which is required to recover an original packet from the uncompressed payload stored to a dictionary 350. Herein, examples of a compression algorithm, which is used to compress the payload of packet, are MD4 (Message Digest 4), MD5 (Message Digest 5), etc. as shown in FIG. 4 (b).

On the one hand, a compressor 200 in accordance with one embodiment of the present disclosure may switch a transfer mode from a normal mode to a compression mode with reference to the switch request of a decompressor 300 to a compression mode. On the other hand, a compressor 200 may switch a transfer mode from a compression mode to a normal mode with reference to the switch request of a decompressor 300 to a normal mode.

In addition, a transfer mode of a compressor 200 in accordance with one embodiment of the present disclosure may set to a normal modes in case that a packet received from a client 400 is transmitted to compressor 200 directly, not via a decompressor 300, which indicates that a client 400 is no longer connected with a decompressor 300 that enables decompression as a result of Hand-Over on a client 400.

### (2) Operation of a Decompressor 300

First, according to one embodiment of the present disclosure, a decompressor 300 can retransmit the packet, which is received from a client 400, as it is to a compressor 200.

According to one embodiment of the present disclosure, in case that a decompressor 300 receives uncompressed packets from a compressor 200, the decompressor can determine whether a payload of the packet is stored to the dictionary by scanning a dictionary 350(data storage). Further, a decompressor 300 in accordance with one embodiment of the present disclosure can record the number of consecutive times of receiving a decompressed packet that contains a payload already stored to a dictionary in session with a compressor 200. As a result, if the number of times that a packet is consecutively stored to a dictionary 350 of a decompressor 300, which is transmitted from a compressor 200 to a decompressor 300 in a specific session, exceeds the configured first threshold, a decompressor 300 may determine that the content transmitted through the session above has been already stored to a dictionary 350 so that a decompressor 300 can send a signal to a compressor 200 requesting a switch of transfer mode to a compression mode. A decompressor 300 can mark a data transfer session that is connected to a compressor 200 and then send a switching signal to change to a compression mode. For instance, a decompressor 300 can send a switching signal to change to a compression mode by marking a reserved flag or an option field of TCP header of the data transfer session that is connected to a compressor 200. The above marking may be a predefined protocol between a compressor 200 and a decompressor 300. In addition, according to another embodiment of the present disclosure, a decompressor 300 may define a data transfer session with a compressor 200 and a proprietary protocol (for example, out-of-band data method) in order to send a switching signal for a compression mode. The above proprietary protocol between a decompressor 300 and a compressor 200 may be a predefined protocol between a decompressor 300 and a compressor 200.

However, according to one embodiment of the present disclosure, in the case that the payload of a packet received from a compressor 200 is not stored to a dictionary 350 of a decompressor 300, a decompressor 300 can compress the payload contained in the packet using a compression algorithm (e.g., MD4, MD5 and the like) and then store both an uncompressed payload and a compressed payload in the dictionary. Herein, a compressed payload can play a roles as an identifier (that is, the key) that specifies the uncompressed payload. In further detail, a decompressor 300 in accordance with one embodiment of the present disclosure can makes a comparison between a compressed payload stored to a dictionary 350 and a compressed payload received from a compressor 200 to determine whether the uncompressed payload corresponding to the compressed payload is stored to a dictionary 350 (that is, whether the content corresponding to the received content from a compressor 200 stored to a dictionary 350 of a decompressor 300).

On the other hand, according to one embodiment of the present disclosure, in case that a decompressor 300 receives packets containing a compressed payload from a compressor 200, the decompressor can determine whether the uncompressed payload corresponding to the compressed payload of the packet is stored to a dictionary 350 by scanning a dictionary 350(data storage) to. In further detail, a decompressor 300 in accordance with one embodiment of the present disclosure can makes a comparison between a compressed payload stored to a dictionary 350 and a compressed payload of a packet received from a compressor 200 to determine whether the uncompressed payload corresponding to the compressed payload of packet received from a compressor 300 is stored to a dictionary 350. As a result, if it is determined that an uncompressed payload corresponding to a compressed payload of a packet received from a compressor 300 is stored to a dictionary 350, it is possible to restore the same packet in terms of transmission as the original one, which the compressor has received from a server 100, using an uncompressed payload stored to a dictionary 350. As a result, a decompressor 300 in accordance with one embodiment of the present disclosure can transmit the restored packet to a client 400.

In contrast, in the case that a compressed payload of a packet received from a compressor 200 is not stored to a dictionary 350 of a decompressor 300, a decompressor 300 can receive a packet containing an uncompressed payload from a decompressor 200 by sending a signal to a compressor 200 requesting a switch of transfer mode to a normal mode. In addition, a decompressor 300 can mark a data transfer session that is connected to a compressor 200 and then send a request to a compressor 200 for switching to a normal mode as described above. Also, as mentioned above, a decompressor 300 may define a data transfer session with a compressor 200 and a proprietary protocol in order to send a request to a compressor 200 for switching to a normal mode.

### (3) Process of Hand-Over in Compression Mode

According to one embodiment of the present disclosure, a compressor 200 and a decompressor 300 are connected to each entry and exit point of a backbone 15 on a communication network 10 between a server 100 and a client 400. A compressor 200 compresses a payload containing data which constructs a content and transmit a packet, which contains the compressed payload, to a decompressor 300. Then a decompressor 300 makes a comparison between a compressed payload stored in its own dictionary 350 and a compressed payload of a packet received from a compressor 200 to determine whether the uncompressed payload corresponding to the compressed payload of packet received from a compressor 200 is stored to a dictionary 350. If the uncompressed payload above is stored to a dictionary 350, a compressor 200 restores a packet to be transmitted to a client with the uncompressed payload corresponding to a compressed payload (key) and then transmit this restored packet to a client 400. Thus, for the packet sent from a server 100 to a client 400 through a compressor 200 and a decompressor 300, it is like that a compressor 200 and a decompressor 300 are not present in transmission process. In other words, this is in effect a system in accordance with the present disclosure is not present during the process and in this case, a process for Hand-Over when it occurs on a client 400 can be done by the conventional mobile communication mechanism.

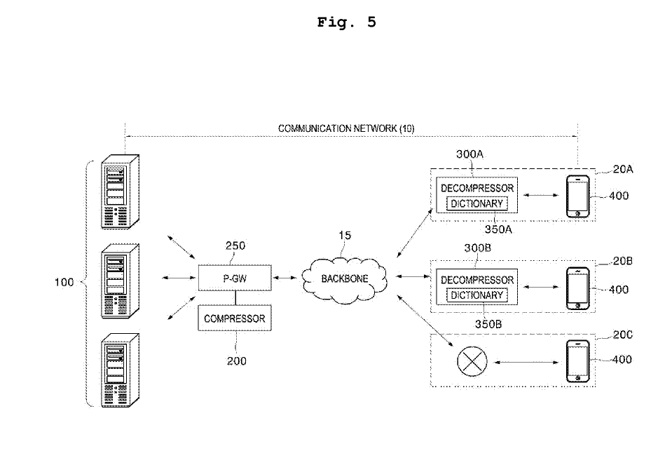

FIG. 5 is a block diagram showing a process of Hand-Over in a compression mode as an example in accordance with to one embodiment of the present disclosure.

With reference to FIG. 5, as a result of Hand-Over while a client 400 is connected to a communication network 1 20A in which a decompressor 1 300A belongs to, a client 400 can be connected to: (i) a communication network 2 20B in which a decompressor 2 300B belongs to; or (ii) a communication network 3 20C in which no decompressors belong. In both cases mentioned above, the delivery of a packet can continue through existing session in accordance with one embodiment of the present disclosure. The following description will now be described in more detail.

First, according to one embodiment of the present disclosure, in case that a transfer mode is a normal mode because a content is not stored to a dictionary of a decompressor 1 300A, a compressor 200 delivers an uncompressed content. Thus, compressor 200 continues to deliver an uncompressed content in normal mode even when a client 400 is handed over to a communication network that is connected to a decompressor 2 300B or to a communication network that is not connected to any decompressors.

Second, according to one embodiment of the present disclosure, in case that a content is stored to a dictionary 350A of a decompressor 1 300A on a communication network 1 20A before the event of Hand-Over and thus, a transfer mode is a compression mode and the content is stored to a dictionary 350B of a decompressor 2 300B on a communication network 2 20B after the event of Hand-Over, a compressor 200 keeps a transfer mode as a compression mode so that it can continue to deliver a compressed content to a decompressor 2 300B. In addition, according to one embodiment of the present disclosure, in case that a content is stored to a dictionary 350A of a decompressor 1 300A on a communication network 1 20A before the event of Hand-Over and thus, a transfer mode is a compression mode and the content is not stored to a dictionary 350B of a decompressor 2 300B on a communication network 2 20B after the event of Hand-Over, a decompressor 2 300B can send a request signal to a compressor 200 to change a transfer mode of the session to a normal mode and then a compressor 200 can transmit an uncompressed content to a decompressor 2 30B by switching a transfer mode from a compression mode to a normal mode. Further, in case that a content is stored to a dictionary 350A of a decompressor 1 300A on a communication network 1 20A before the event of Hand-Over and thus, a transfer mode is a compression mode and a decompressor does not exist in a communication network after the event of Hand-Over, a compressor 200 can transmit an uncompressed content directly to a client 400 by changing a transfer mode from a compression mode to a normal mode when detecting that a packet received from a client 400 does not go through a decompressor.

(4) Another Embodiment relates to Compression Transmission of a Content

In another aspect of the present disclosure, a compressor 200 can transmit a compressed content by including the content not in a payload of packet but in the option field of TCP header (Transmission Control Protocol Header) of a packet if a transfer mode is a compression mode. Hereinafter, embodiments of the delivery of a compressed content via the option field of TCP header (Transmission Control Protocol Header) of a packet will now be described in more detail.

First, in another aspect of the present disclosure, a compressor 200 can retransmit the uncompressed packet to a decompressor 300 in normal mode, which is received from a server 100.

Next, in another aspect of the present disclosure, a compressor 200 compresses a content received from a server 100 based on configured compression algorithm when a transfer mode is changed from a normal mode to a compression mode upon receiving a switching request to a compression mode from a decompressor 300 and then generate a packet containing a compressed content by storing (so to speak, loading) the compressed content above to the option field of a packet's TCP header and also empting a payload of a packet. Furthermore, a compressor 200 may transmit the above compressed packet to a decompressor 300 and also transmit metadata (e.g., compressed MD5 signature information, protocol information and the like), which is required to recover an original packet, from an uncompressed content stored to a dictionary 350 of a decompressor 300.

Next, in another aspect of the present disclosure, in case that a decompressor 300 receives a packet containing a compressed content in the option field of a TCP header from a compressor 200, a decompressor can make a comparison between a compressed content stored in its own dictionary 350 and a compressed content stored to the option field of the TCP header of the packet received from a compressor 200 to determine whether the uncompressed content corresponding to the compressed content received from a compressor 200 is stored in its own dictionary 350. As a result, if it is determined that an uncompressed content corresponding to a compressed content stored to the option field of the TCP header of the packet received from a compressor 200 is stored to a dictionary 350, it is possible to restore the same packet in terms of transmission as the original one which is received from a server 100 using an uncompressed content stored to a dictionary 350. Accordingly, a decompressor 300 in accordance with one embodiment of the present disclosure can the restored packet to a client 400.

Further, in another aspect of the present disclosure, when a Hand-Over occurs on a client 400, it gives rise to three cases such as followings.

First, according to another embodiment of the present disclosure, in case that a content is stored in a dictionary of a decompressor 1 300A on a communication network 1 20A before the event of Hand-Over and thus, a transfer mode is a compression mode and its content is stored to the same manner as above in a dictionary of a decompressor 2 300B on a communication network 2 20B after the event of Hand-Over, a compressor 200 keeps a transfer mode as a compression mode so that it can continue to deliver a packet containing a compressed content stored in the option field of the TCP header of the packet to a decompressor 2 300B;

Second, according to another embodiment of the present disclosure, in case that a content is stored only in a dictionary 350A of a decompressor 1 300A on a communication network 1 20A before the event of Hand-Over and thus, a transfer mode is a compression mode and its content is not stored to a dictionary 350B of a decompressor 2 300B on a communication network 2 20B after the event of Hand-Over, a decompressor 2 300B can send a request signal to a compressor 200 to change a transfer mode of the session to a normal mode and then a compressor 200 can transmit an a packet, which contains an uncompressed content in payload, to a decompressor 2 300B by switching a transfer mode from a compression mode to a normal mode.

Third, according to another embodiment of the present disclosure, in case that a content is stored only in a dictionary 350A of a decompressor 1 300A on a communication network 1 20A before the event of Hand-Over and thus, a transfer mode is a compression mode and a decompressor does not exist in a communication network 3 20C after the event of Hand-Over, a compressor 200 can transmit a packet contains a compressed content, wherein a compressed content is included in an option field of a TCP header and the data for the content is not included in a payload, directly to a client 400. The packet that is sent to a client 400 does not contain a payload and besides, a compressed content in an option field of a TCP header of this packet can be ignored by a client 400 if it could not be interpreted. Thus, in such cases, a client 400 may send a request (or a message) to retransmit the packet to a server 100 via TCP session. A compressor 200 in accordance with one embodiment of the present disclosure can check the status of a TCP session that is established between a client 400 and a server 100 so it can switch the transfer mode from a compression mode to a normal mode after recognizing that a decompressor does not exist on a communication network 2 in which a client 400 belongs to according to a packet retransmission request from a client 400. Like this after a transfer mode is switched from a compression mode to a normal mode, a compressor 200 can retransmit an uncompressed packet, which is received from a server 100, to a client 400.

According to the conventional technology, in order to transmit a packet to a specific client, a packet should be sent to a specific decompressor and in order to transmit a packet to a specific server, a packet should be sent to a specific compressor. As a result, it a compressor and a decompressor should search for each other among multiple compressors and decompressors within a content transmission system, which causes a burden of constant checking or managing the status of a counterpart. However, according to the above embodiment of the present disclosure, a compressor transmits a packet to a specific client, which is a destination of packet transmission and then a decompressor exists in the transmission path can receive the packet for required processes. In contrast, a decompressor transmits a packet to a specific server, which is a destination of a packet transmission and then a compressor exists in the transmission path can receive the packet for required process. If necessary, a tunnel formed between a compressor and a decompressor can support the packet transmission so that it can relieve the burden of resulting from the conventional technology.

### Cache Mode and Configuration of the Hand-Over in Cache Mode

Hereinafter, the configuration of content delivery using cache mode and the configuration of Hand-Over in cache mode according to one embodiment of the present disclosure will be described in detail.

As described above in relation to the compression mode, a decompressor 300 in accordance with one embodiment of the present disclosure stores a content received from a server 100 to a dictionary 350 of a decompressor 300. If all parts of the content received a server 100 are stored to a dictionary 350 of a decompressor 300, a decompressor 300 does not need to receive the content from a server 100 and a decompressor 300 can transmit the content to a client 400 using the content stored in its own dictionary 350. According to the present invent, the transmission mode mentioned above is referred as “cache mode”.

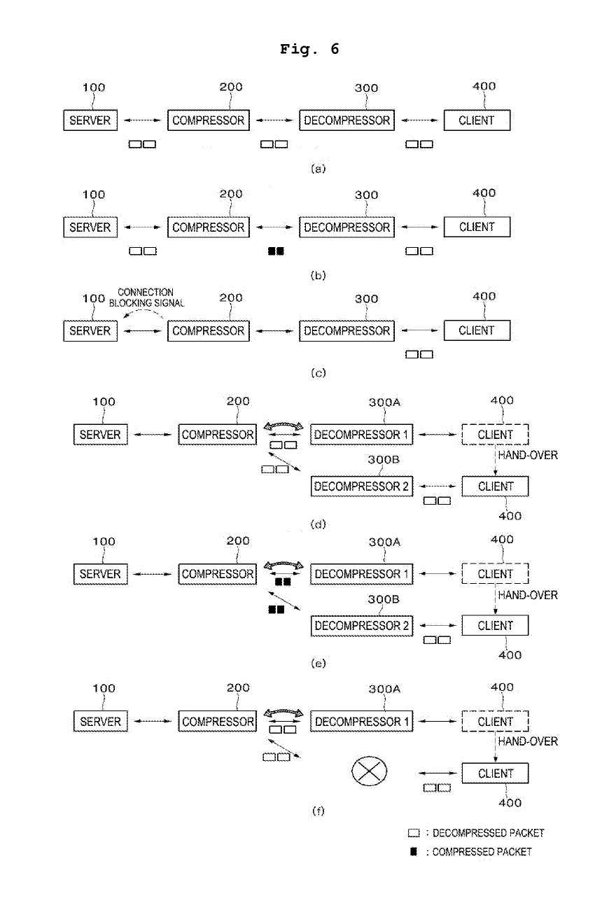

FIG. 6 is a block diagram showing the delivery of contents in cache mode in accordance with one embodiment of the present disclosure.

### (1) Operation of a Compressor 200

First, according to one embodiment of the present disclosure, a compressor 200 may have the information in relation to whether a decompressor 300 is located in the lower part of each communication network in which a client 400 belongs to. Since the packet, which starts from a client 400, must go through a compressor 200 before it reaches to a server 100 via a decompressor 300, a compressor 200 may determine whether a decompressor 300 exists in the lower part of a communication network in which a client 400 belongs to.

A compressor 200 in accordance with to one embodiment of the present disclosure may receive a data, which compromises a content, from a server 100 as a packet consisting of packet header and payload (so to speak, actual data). Herein, it does not establish a TCP connection between a compressor 200 and a sever 100 in the transport layer, whereas, a compressor 200 receives a datagram packet from a server 100 in the network layer.

According to one embodiment of the present disclosure, a compressor 200 can retransmit the uncompressed packet, which is received from a server 100, to a decompressor 300 in normal mode as shown in FIG. 6 (a).

According to one embodiment of the present disclosure, a compressor 200 compresses the payload of packet, which is received from a server 100, in compression mode using configured compression algorithm, in order to generate a compressed packet. Furthermore, a compressor 200 may transmit the above compressed packet to a decompressor 300 and transmit metadata (e.g., compressed MD5 signature information, protocol information and the like) as well, which is required to restore the same packet in terms of transmission as the original one that is received from a server 100 using an uncompressed payload stored to a dictionary 350 of a compressor 300. Herein, examples of a compression algorithm, which is used to compress the payload of packet, are MD4 (Message Digest 4), MD5 (Message Digest 5), etc. as shown in FIG. 6 (b).

According to one embodiment of the present disclosure, in case that a transfer mode is a cache mode, a compressor 200 sends a connection blocking signal (RST) to a server 100 to terminate a connection with a server 100 as shown in FIG. 6 (c) if a compressor 200 has been receiving a content from a server 100 or a compressor 200 may terminate the tunnel if a compressor 200 has been receiving a content through a tunnel from another decompressor 300.

Besides, a compressor 200 in accordance with one embodiment of the present disclosure can manage the information of a client 400 and a decompressor 300, which are connected to each other in the corresponding session. In this way, a decompressor 200 in the session can determine whether Hand-Over occurs.

A compressor 200 in accordance with one embodiment of the present disclosure may perform a relevant function according to each transfer mode (e.g., normal mode, compression mode and cache mode) with reference to a switch request of a transfer mode from a decompressor or information regarding whether the packet received from a client passes through a decompressor 300. In further detail, a compressor 200 in accordance with one embodiment of the present disclosure may compress and transmit a content in response to receiving a switch request to a compression mode from a decompressor 300 or stop transmitting a content in response to receiving a switch request to a cache mode from a decompressor 300. In addition, a present transfer mode of a compressor 200 in accordance with one embodiment of the present disclosure may set to a normal modes in case that a packet received from a client 400 is transmitted to compressor 200 directly, not via a decompressor 300, which indicates that the client 400 is no longer connected with a decompressor 300 that enables decompression as a result of Hand-Over on a client 400.

Next, according to one embodiment of the present disclosure, in case that Hand-Over occurs on a client 400 while a content is transmitted in cache mode, a compressor 200 may open up a tunnel for a decompressor 1 300A, which is connected with a client 400 before the event of Hand-Over, using tunneling technology. In this case, a compressor 200 transmits the packet (so to speak, a packet with regard to the content request) received from a client 400 to a decompressor 1 300A through the tunnel. In response, a decompressor 1 300A may transmit a packet, which responds to a request from a client 400, to a compressor 200 through the tunnel. Then the packet that is transmitted from decompressor 1 300A to a compressor 200 through the tunnel, which is formed between a decompressor 1 300A and a compressor 200, can be transmitted to a decompressor 2 300B or a client 400 that has been handed over. Like this, according to the present disclosure, a client 400 can continuously receive cached contents via a decompressor 300B or directly from a decompressor 300A that has been connected to a client 400 before the event of Hand-Over even when Hand-Over occurs on a client 400 as shown in FIG. 6 (d), (e) or (f).

In further detail, according to one embodiment of the present disclosure, in case that a decompressor does not exist between a compressor 200 and a client 400 after the event of Hand-Over, the packet tunneled from a decompressor 1 300A, which has been connected with a client 400 before the event of Hand-Over, can be sent to a client 400 through a compressor 200.

Further, according to one embodiment of the present disclosure, in case that a decompressor 2 300B exists between a compressor 200 and a client 400 after the event of Hand-Over, the packet tunneled from a decompressor 1, which has been connected with a client 400 before the event of Hand-Over, can be sent to a client 400 through a compressor 200 and a decompressor 2 300B.

### (2) Operation of a Decompressor

First, according to one embodiment of the present disclosure, for the packet that is received from a client 400, a decompressor 300 can retransmit it to a compressor 200 without any processing.

According to one embodiment of the present disclosure, a decompressor 300 can manage the received metadata, such as content type, content length, URL, etc., from the session in case that packets are received from a compressor 200, which contains uncompressed payload. In further detail, it may be determined whether or not the session starts from the beginning by referring to SYN number of a packet, which is received from a compressor 200. As a result, if the session starts from the beginning, a decompressor 300 scans a payload of a packet to extract and manage the metadata such as content type, content length and URL. If the session starts from the middle, a decompressor 300 may receive and manage the metadata of the session after requesting it to a compressor 200. On the other hand, according to one embodiment of the present disclosure, a decompressor 300B can manage the received metadata, such as content type, content length, URL, etc., from the session in case that packets are received from another decompressor 300A, which contains uncompressed payload. In further detail, it may be determined whether or not the session starts from the beginning by referring to SYN number of a packet, which is received from another decompressor 300A. As a result, if the session starts from the beginning, a decompressor 300B scans a payload of a packet to extract and manage the metadata such as content type, content length and URL. If the session starts from the middle, a decompressor 300B may receive and manage the metadata of the session after requesting it to another decompressor 300A.

According to one embodiment of the present disclosure, in case that a decompressor 300 receives a packet containing uncompressed payload from a compressor 200, the decompressor 300 scans a dictionary 350(data storage) to determine whether a payload of the packet is stored to the dictionary 350. Further, a decompressor 300 in accordance with one embodiment of the present disclosure can record the number of consecutive times of receiving a decompressed packet that contains a payload already stored to a dictionary in session with a compressor 200. As a result, if the number of times that a packet (that is, the packet transmitted from a compressor 200 to a decompressor 300 in a specific session) is consecutively stored to a dictionary 350 of a decompressor 300 exceeds the configured first threshold, a decompressor 300 may determine that the content transmitted through the session above has been already stored to a dictionary 350 so that a decompressor 300 can send a signal to a compressor 200 requesting a switch of transfer mode to a compression mode.

According to one embodiment of the present disclosure, if the number of times that a packet (that is, the packet transmitted from a compressor 200 in a specific session) is consecutively stored to a dictionary 350 of a decompressor 300 exceeds the configured second threshold, in other words, if it is determined that a content transmitted via a session and a content stored to a dictionary 350 matches each other continuously more than a predetermined level, and a session metadata and a metadata of the content stored to a dictionary 350 matches each other, and the entire part of the content is completely stored to dictionary 350, a decompressor 300 can send a signal to a compressor 200 requesting a switch of transfer mode to a cache mode. A decompressor 300 can mark a data transfer session that is connected to a compressor 200 and then send a switching signal to change to a cache mode. For instance, a decompressor 300 can send a switching signal to change to a cache mode by marking a reserved flag or an option field of TCP header of the data transfer session that is connected to a compressor 200. The above marking may be a predefined protocol between a compressor 200 and a decompressor 300. In addition, according to another embodiment of the present disclosure, a decompressor 300 may define a data transfer session with a compressor 200 and a proprietary protocol (for example, out-of-band data method) in order to send a switching signal for a cache mode. The above proprietary protocol between a decompressor 300 and a compressor 200 may be a predefined protocol between a decompressor 300 and a compressor 200. Additionally, a decompressor 300 can transmit a content, which has been stored in its own dictionary 350, to a client 400, without receiving a content from a server 100 when a transfer mode is switched to a cache mode. According to one embodiment of the present disclosure, a signal requesting a switch to a cache mode may contain a connection information (so to speak, the information about IP address and TCP port) of a client 400 on the session and Finish (FIN) signal may be sent to a client 400 after the delivery of contents is complete.

Herein, according to one embodiment of the present disclosure, the second threshold for a cache mode may be set larger than the first threshold for a compression mode.

Next, according to one embodiment of the present disclosure, in case that Hand-Over occurs on a client 400 while a content is transmitted in cache mode, the packet transmitted from a decompressor 1 300A, which is has been connected with a client 400 before the event of Hand-Over, can be sent to a decompressor 2 300B, which is connected to a client after the event of Hand-Over, through a compressor 200.

In this case, a decompressor 1 300A does not transmit the packet on a communication network before the event of Hand-Over. Instead, in response to the packet (so to speak, a packet with regard to the content request) received from a client 400 through a tunnel formed by a compressor 200, it can transmit the packet, which is corresponding to a packet from a client 400, through the tunnel by switch of routing. Additionally, according to one embodiment of the present disclosure, a decompressor 1 300A may transmit a metadata of a content to a compressor 200 through a tunnel in respond to a request from a compressor 200 or a request received from a decompressor 2 300B through a tunnel.

According to one embodiment of the present disclosure, in case that a payload of a packet received from a compressor 200 does not exist in a dictionary 350B of a decompressor 2 300B, a decompressor 2 300B may compress the payload using the configured compression algorithm (e.g., MD4, MD5 and the like) and store a compressed payload and an uncompressed payload as a pair of key and value to a dictionary 350B. Herein, a dictionary 350 in accordance with one embodiment of the present disclosure may manage a payload by the content and store it in conjunction with a metadata of an individual content. In some cases, a single payload may be shared among multiple contents so a dictionary 350 is able to avoid the duplication of a payload when managing the stored payload. Herein, it is possible to take advantage of such techniques that a number of contents individually refer to a single payload physically stored in a dictionary 350.

According to one embodiment of the present disclosure, in case that a decompressor 300 receives packets containing compressed payload from a compressor 200, a decompressor scans a dictionary 350(data storage) to determine whether the payload that matches the compressed payload has been stored to a dictionary 350. As a result, if it is determined that a compressed payload of a received packet is stored to a dictionary 350, a decompressor 300 generates the same or equivalent packet in terms of transmission as the original one (so to speak, the packet that a compressor 200 has received from a server 100) that is received from a server 100 and then transmit it to a client 400 using the payload stored in a dictionary 350 plus a metadata required for restoring. In contrast, in the case that a compressed payload of a received packet is not stored in a dictionary 350, a decompressor 300 can receive a packet containing an uncompressed payload from a compressor 200 by sending a signal to a compressor 200 requesting a switch of transfer mode to a normal mode. As described above, a decompressor 300 can send a switching signal to a compressor 200 to change to a normal mode.

(3) Hand-Over in Cache mode

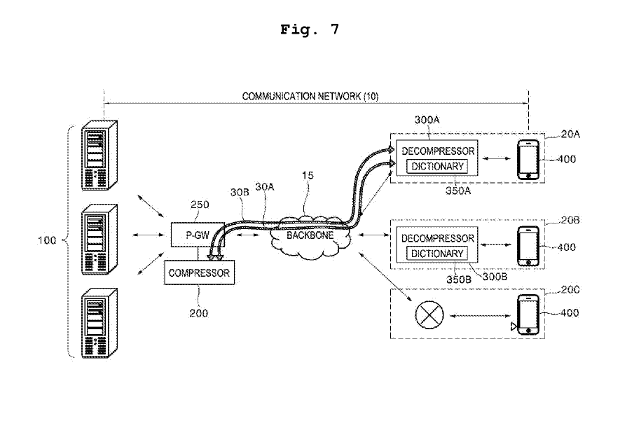

FIG. 7 is a block diagram showing how a Hand-Over is implemented in cache mode in accordance with one embodiment of the present disclosure by way of illustration.

With reference to FIG. 7, as a result of Hand-Over while a client 400 is connected to a communication network 1 20A in which a decompressor 1 300A belongs to, a client 400 can be connected to: (i) a communication network 2 20B in which a decompressor 2 300B belongs to; or (ii) a communication network 3 20C in which no decompressors belong to. In both cases mentioned above, a configuration that supports Hand-Over will now be described more specifically as follow.

First, if a client 400 belongs to a communication network 2 that is connected a decompressor 2 300B as a result of Hand-Over in case of (i) mentioned above, a packet transmitted from a client 400 reaches to a compressor 200 via a decompressor 2 300B and then this packet may be transmitted to a decompressor 1 300A by tunneling 30A. In contrast, a packet transmitted from decompressor 1 300A reaches to a compressor 200 by tunneling 30A and then this packet may be transmitted to a decompressor 2 300B. Thus, a content is transmitted through a connection link such as “client 400-decompressor 2 300B-compressor 200-tunnel 30A-decompressor 1 300A”.

Furthermore, according to one embodiment of the present disclosure, a decompressor 2 300B compares the received packets from a decompressor 1 300A to the payload stored to a dictionary 350B of a decompressor 2 300B to determine whether the payload is stored in its own dictionary 350B.

As a result, if it is determined that a content and a metadata stored in a dictionary 350B of a decompressor 2 300B and a content and a metadata transmitted to a decompressor 2 300B consecutively match each other more than the first threshold, it may be treated as already having been stored to a dictionary 350B of a decompressor 2 300B to some extent. Therefore, a decompressor 2 300B can send a signal to a decompressor 1 300A via a compressor 200 requesting a switch of transfer mode to a compression mode. As described above, a decompressor 2 300B can send a switching signal to a decompressor 1 300A to change to a compression mode via a compressor 200. The description above also illustrates a method of sending a mode switching signal among a decompressor 2 300B, a compressor 200 and a decompressor 1 300A. Accordingly, a decompressor 1 300A may compress a content stored in its own dictionary 350A using configured compression algorithm to generate a compressed packet and then transmit the above compressed packet to a decompressor 2 300B. Furthermore, a decompressor 1 300A may transmit a metadata, which is required to restore the same or equivalent packet in terms of transmission as the original one that is transmitted from a server 100 to a compressor 200 using an uncompressed content that is stored in a dictionary 350B of a decompressor 300B, to a decompressor 2 300B as well as shown in FIG. 6 (e). As described above, according to the present disclosure, since a compressed content can be transmitted, even when a content is transmitted from a decompressor 1 300A to a compressor 200 and then transmitted again from a compressor 200 to a decompressor 2 300B through a tunnel, it is possible to reduce backbone traffic, even when a content is transmitted through a tunnel after Hand-Over.

As a result, if it is determined that a content and a metadata stored in a dictionary 350B of a decompressor 2 300B and a content and a metadata transmitted to a decompressor 2 300B consecutively match each other more than the second threshold, the entire content may be treated as being completely stored to a dictionary 350B of a decompressor 2 300B. Therefore, a decompressor 2 300B can send a signal to a decompressor 1 300A via a compressor 200 requesting a switch of transfer mode to a cache mode. Accordingly, a compressor 200 can terminate a tunnel formed between a decompressor 1 300A and a compressor 200, and update the administrative status informing that a decompressor communicated with a client 400 has been switched from a decompressor 1 300A to a decompressor 2 300B. As described above, a decompressor 2 300B can send a switching signal to a decompressor 1 300A to change to a cache mode via a compressor 200. The description above also illustrates a method of sending a mode switching signal among a decompressor 2 300B, a compressor 200 and a decompressor 1 300A. Thus, a client 400 receives a cached content that is stored in a dictionary 350B of a decompressor 2 300B but no longer receive a content from a decompressor 1 300A.

As described above, in case that Hand-Over occurs repeatedly on a client 400, the following process can occur repeatedly: a process of transmitting a content through a tunnel 30A that is established for a decompressor before Hand-Over; and a process of transmitting a content from a decompressor after Hand-Over when a transfer mode of a decompressor switches to a cache mode if a content that is transmitted consecutively more than a configured threshold matches a content that is stored in a dictionary of a decompressor after Hand-over and then stopping the delivery of a content from a decompressor before Hand-Over.

Second, if a client 400 belongs to a communication network 3 20B that has no connection with any decompressors as a result of Hand-Over in case of (2) mentioned above, a packet transmitted from a client 400 may reach to a decompressor) 300A via a compressor 200 by tunneling 30B. In contrast, a packet transmitted from decompressor 1 300A reaches to a compressor 200 by tunneling 30B and then it may be transmitted again to a client 400. Thus, a content is transmitted through a connection link such as “client 400-compressor 200-tunnel 30B-decompressor 1 300A”.

As described above, in case that a Hand-Over occurs repeatedly on a client 400, a content is transmitted through an established tunnel 30B between a compressor 200 and a decompressor that has been connected with the client 400 before the event of Hand-Over.

In addition, embodiments of the present disclosure further relate to computer storage products with a computer-readable medium that contain program code for performing various computer-implemented operations. The computer-readable medium is any data storage device that can store data which can thereafter be read by a computer system. The media and program code may be those specially designed and constructed for the purposes of the present disclosure, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter.

While embodiments of the present disclosure has been shown and described, it will be understood by those skilled in the art that various changes and modifications may be made without departing from the spirit and scope of the present disclosure as defined in the following claims.

1. A method of delivering contents enabling hand-over, comprising:
(a) transmitting, by a decompressor, a switching request to a compression mode or a cache mode to a compressor, based on the degree of matching between a content stored in a dictionary of the decompressor and a content transmitted from the compressor to the decompressor;
(b) transmitting, by the decompressor, contents to a client based on the contents stored in the dictionary of the decompressor based on the transfer mode; and
(c) performing, by the decompressor, one of operations which i) stopping the transmission of the contents to the client or ii) transmitting the contents stored in the dictionary of the decompressor by tunneling based on the transfer mode when hand-over occurs on the client.

2. The method of claim 1,
further comprising,
receiving compressed contents from the compressor, if the transfer mode is a compression mode, and
wherein the step (b) comprises,
transmitting, by the decompressor, the content corresponding to a content that is compressed and transmitted by the compressor to the client among contents stored in the dictionary of the decompressor.

3. The method of claim 1,
if the transfer mode is the cache mode,
wherein the transmission of the contents between the compressor and the decompressor is stopped,
wherein the step (b) comprises,
transmitting, by the decompressor, the contents stored in the dictionary of the decompressor to the client.

4. The method of claim 1,
if the transfer mode is the compression mode,
wherein the step (c) comprises,
stopping, by a decompressor, the transmission of the contents to the client based on the transfer mode when hand-over occurs on the client.

5. The method of claim 1,
if the transfer mode is the cache mode,
wherein the step (c) comprises,
performing tunneling, by the decompressor, to allow the cached contents stored in the dictionary of the decompressor to be transmitted to the client or to another decompressor connected to the client after hand-over when hand-over occurs on the client.

6. The method of claim 2,
further comprising,
receiving, by the decompressor, the metadata from the compressor, which is required to recover the same packet in terms of transmission as a packet transmitted from a server to the compressor.

7. The method of claim 5,
wherein the step (c) further comprises,
receiving a switching request to a compression mode from another decompressor, if the number of matches between a packet of a content transmitted from the decompressor to said another decompressor and a packet of a content stored in a dictionary of said another decompressor is more than and equal to the first threshold; and
transmitting, by the decompressor, the content stored in the dictionary of the decompressor by compressing the content when receiving a switching request to a compression from said another decompressor.

8. The method of claim 5,
wherein the step (c) further comprises,
receiving a request to a cache mode from another decompressor, if the number of matches between a packet of a content transmitted from the decompressor to said another decompressor and a packet of a content stored in the dictionary of said another decompressor is more than or equal to a second threshold; and
stopping, by the decompressor, the transmission of the content that is stored in the dictionary of the decompressor when receiving a switching request to cache mode from said another decompressor.

9. The method of claim 1,
wherein the step (a) comprises,
transmitting a switching request to the compression mode or the cache mode by marking in data transmission session between the compressor and the decompressor, or defining a proprietary protocol and a data transmission session.

10. A method for delivering contents enabling hand-over, comprising:
(a) receiving, by a compressor, a switching request to a compression mode or a cache mode from the decompressor, based on the degree of matching between a content stored in a dictionary of the decompressor and a content transmitted from the compressor to the decompressor;
(b) by the compressor, stopping to transmit contents that are received from a server to the decompressor based on the transfer mode, or compressing and then transmitting contents that are received from the server to the decompressor; and
(c) performing, by the compressor, one of operations which i) transmitting contents received from the server to the client or another decompressor connected to the client after hand-over, or ii) controlling cached contents that are stored in the dictionary of the decompressor to be transmitted to the client or another decompressor connected to the client by tunneling based on the transfer mode when hand-over occurs on the client.

11. The method of claim 10,
if the transfer mode is the compression mode,
wherein the step (b) comprises,
compressing and transmitting, by the compressor, contents that are received from the server to the decompressor; and
wherein the step (c) comprises,
transmitting, by the compressor, contents received from the server to the client or to another decompressor connected to the client without compression after hand-over when hand-over occurs on the client.

12. The method of claim 10,
if the transfer mode is the cache mode,
wherein the step (b) comprises,
stopping, by the compressor, to transmit contents received from the server to the decompressor; and
wherein the step (c) comprises,
allowing, by the compressor, control of transmitting cached contents stored in the dictionary of the decompressor to the client or to another decompressor by tunneling when hand-over occurs on the client.

13. The method of claim 10, further comprising,
(d) determining, by the compressor, that hand-over occurs on the client if a decompressor which a packet is transmitted from the client is changed or a packet transmitted from the client is received by the compressor without going through a decompressor.

14. The method of claim 1,
wherein the compressor and the decompressor communicate in a network layer in which datagram is transmitted and received.

15. The method of claim 2,
wherein a content compressed by the compressor is included in the option field of TCP (Transmission Control Protocol) header of a packet that is transmitted to the client.

16. The decompressor of contents delivery system for enabling hand-over, comprising:
a compression processor of the decompressor configured to:
transmit a switching request to either a compression mode or a cache mode to a compressor, based on the degree of matching between a content stored in a dictionary of the decompressor and a content transmitted from the compressor to the decompressor, and
transmit the contents corresponding to contents stored in the dictionary of the decompressor to the client based on the transfer mode; and
a hand-over processor of the decompressor configured to:
perform one of operations, which is stopping the transmission of contents to the client or transmitting cached contents stored in the dictionary of the decompressor by tunneling based on the transfer mode when hand-over occurs on the client.

17. The compressor of contents delivery system for enabling hand-over, comprising;
a compression processor of the compressor configured to:
receive a switching request to a compression mode or a cache mode from the decompressor, based on the degree of matching between a content stored in a dictionary of the decompressor and a content transmitted from the compressor to the decompressor, and
stop transmitting contents received from a server to a client or transmit contents received from server by compressing the contents to the decompressor, based on the transfer mode; and
a hand-over processor of the compressor configured to:
perform one of operations, which is transmitting contents received from the server to the client or to another decompressor connected to the client after hand-over, or controlling to allow the cached contents stored in a dictionary of the decompressor to be transmitted to another decompressor by tunneling based on the transfer mode when hand-over occurs on the client.

18. Computer-readable medium comprising computer-program code for performing method according to claim 1.
